(19) United States
(12) Patent Application Publication
(10) Pub. No.: US 2010/0313031 A1
(43) Pub. Date: Dec. 9, 2010

(54) WATERMARKING DURING SYSTEM DEPLOYMENT

(76) Inventors: Bertrand Jaslet, Mouilleron le Captif (FR); Mark Stout, North Sioux City, SD (US); Christian Leman, Austin, TX (US)

Correspondence Address: JACKSON WALKER L.L.P.;ATTN: INTELLECTUAL PROPERTY DEPARTMENT, 100 CONGRESS AVENUE, SUITE 1100, AUSTIN, TX, 78701, US

(21) Appl. No.: 12/478,409

(22) Filed: Jun. 4, 2009

(51) Int. Cl. H04L 9/32; G06F 21/00

(52) U.S. Cl. 713/176; 726/27

(57) ABSTRACT

A method and system for monitoring the deployment of digital content by transferring a plurality of watermark codes to the target system. The deployment may represent an installation of a software image on a computer or on another type of target system. The watermark code may include machine information and state information, and may be an encrypted code. Additional executable code for securing against watermark violations during the lifetime of the target system may be transferred to the target system during deployment.

### BACKGROUND

1. Field of the Disclosure

The present disclosure relates to the deployment of target systems and, more particularly, to the deployment of digital content to target systems.

2. Description of the Related Art

The transfer of digital content to large numbers of target systems in mass production or mass distributed environments may be performed using specialized deployment systems. A deployment system may include a deployment application executing on a deployment server. The digital content may represent or include a software image for the target system. Usage of the deployment application and certain software applications included in the digital content may be governed by licensing terms and conditions.

### BRIEF DESCRIPTION OF THE DRAWINGS

FIG. 1 is a block diagram of selected elements of an embodiment of a watermarking system;

FIG. 2A is a block diagram of selected elements of an embodiment of a target system;

FIG. 2B is a block diagram of selected elements of an alternate embodiment of a target system;

FIG. 3 is a block diagram of selected elements of an embodiment of a deployment system;

FIG. 4 is a block diagram of selected elements of an embodiment of a computing device;

FIG. 5 is a flow diagram of selected elements of an embodiment of a watermark deployment method;

FIG. 6 is a flow diagram of selected elements of an embodiment of a watermark locking method;

FIG. 7 is a flow diagram of selected elements of an embodiment of a watermark registering method; and

FIG. 8 is a flow diagram of selected elements of an embodiment of a watermark registering method.

### DESCRIPTION OF THE EMBODIMENT(S)

Mass manufacturing or remanufacturing of digital processing systems often includes installing digital content on the systems. In this context, the systems on which digital content is installed are referred to as “target systems.” The term “target system” as used in this disclosure encompasses substantially any electronic device or apparatus with the capacity to store information, execute instructions, and receive information from and/or send information to other electronic devices. A partial list of exemplary target systems include desktop computers, mobile and wireless devices including laptop or notebook computers, netbooks, tablet PCs, personal digital assistants (PDAs) and other handheld computers, smart phones and other network-aware telephony devices, portable media players including audio book devices, electronic or video game devices, touch or pen operated devices, network appliances including routers, gateways, modems, and access points, and set top boxes and other multimedia processing devices. As used in this disclosure, “digital content” encompasses substantially all forms of electronically stored digital information. In some contexts referred to in this disclosure, digital content may emphasize a software image that is installed on a target system. A software image may be unique to the individual system on which it is installed. For example, a software image may be hardware-specific and/or customer specific. The tasks associated with obtaining the digital content and transferring the desired digital content to the appropriate target system are collectively referred to herein as “deployment” or “deploying” and may be performed by a “deployment system.” A deployment system may thus perform specialized tasks in a mass production environment for deploying individualized digital content to a plurality of target systems.

Further, a deployment system may transfer digital content to target systems during an operational lifetime of the target system. That is, deployment may be performed in a distributed manner on a number of target systems in the possession of end users. Such deployment operations may include the transfer of software updates, software upgrades, along with restorations or repair of previously deployed software images.

In certain embodiments, a deployment system includes a deployment application executing on a deployment server. In addition to the actual transfer of digital content, the deployment application may perform additional tasks. For example, the deployment application may be configured to track and record individual deployments, or deployment orders, create reports, and send notifications for various purposes, such as billing, quality control, performance control, reliability, maintenance, and license control among others.

In particular implementations, the deployment application may be associated with various licensing terms and conditions among different parties. In one case, the deployment application itself may be subject to a license agreement that depends upon a number of transactions performed by a particular instance of the deployment application on a particular deployment server. For example, a vendor of a target system may obtain a license to operate a deployment application from an owner of the deployment application. This license may be correlated to a volume of target systems deployed by one or more instances of the deployment application. Other criteria, such as time or data throughput, may also be used as licensing criteria. Furthermore, the deployment application may track elements in the digital content, such as applications in a software image and/or content libraries, for the purpose of accounting or enforcing licensing rights associated with the deployment of the digital content.

In this context, the licensing rights potentially affected by the deployment system may be distributed among various parties, who may act as buyers, sellers, or intermediaries. The parties associated with the deployment system may include the vendor of the digital content, the vendor of the target system, the owner of the deployment system or application, the purchaser of the target system, and the end user of the target system, among others. A violation of a volume-dependent licensing agreement by one party may result in economic losses to another party. Since the licensed deployment activity and/or digital content may be embodied by intangible actions or data, a violation of a licensing agreement might be difficult to detect.

Some embodiments of a deployment application may be configured with means to mark or track the deployment and/or the digital content. As described in detail herein, a watermark code may be implemented by the deployment system as a tracking means to uniquely identify the deployment and/or the digital content transferred to each target system. The deployment application may generate a watermark code unique to each target system. The watermark code may include machine information and state information. The machine information may be associated with an identity of a particular system, such as the deployment system or the target system. The state information may include global environmental information, such as a date and time associated with the deployment, or information associated with the digital content. For enhanced security, the watermark code may be transferred as an encrypted code.

In some embodiments, the deployment system may transfer a plurality of instances of the watermark code to the target system. The transferred instances of the watermark code may be stored on one or more storage partitions on or configured for use with the target system. The instances of the watermark code stored on the target system may include at least one instance written to a storage partition by addressing a location of the storage partition. The instances of the watermark code may also include at least one instance written to a data file under control of a file system installed on the storage partition. In some embodiments, different watermark codes stored on the target system may be used for specific tracking purposes, such as tracking a particular element in a software image.

Due to their uniqueness and multiple instances, watermark codes may serve as a marker incorporating information specific to the target system. The consistency and/or presence of multiple instances of a watermark code on a target system may later serve as an indication of the state of the target system upon future detection. The existence of identical watermark codes on multiple target systems may serve as an indication of a potential license violation. In certain embodiments, watermark interaction code may be executed to interact with the watermark code(s) stored on the system, as will be described in detail below.

In one aspect, a disclosed method for watermarking a target system may include generating a watermark code including machine information and state information, and transferring a plurality of instances of the watermark code to the target system. The watermark code may be an encrypted code. At least one instance of the watermark code may be transferred to a data file. At least one instance of the watermark code may be transferred by addressing a location of a storage partition accessible to the target system. Operations associated with the transferring may be performed during deployment of digital content to the target system.

The machine information may include server information specific to a server performing the deployment. The state information may include date and time information associated with the deployment. At least one watermark code may be transferred to a network server. Method operations associated with the deployment may include creating a plurality of storage partitions including a boot partition and a data partition. At least one watermark code may be transferred to the boot partition. The machine information may include target system information specific to the target system. The state information may include version information for digital content loaded on the target system. Method operations associated with the transferring the plurality of watermark codes may include determining an address for storing at least one of the watermark codes based at least in part on the watermark code.

In a further aspect, a disclosed computer system, referred to herein as a deployment system, for deploying a software image to a target system may include a processor, an I/O port configured for enabling communication between the deployment system and the target system, and memory media accessible to the processor. The memory media may include processor executable instructions to receive an indication specifying the software image to be deployed to the target system, create at least one unique, encrypted watermark code associated with the target system, deploy the specified software image to the target system, and store at least one instance of the watermark code(s) on the target system.

The deployment system may further include processor executable instructions to transfer a lock module to the target system for locking the software image. The lock module may include instructions executable by the target system to compare the machine information with a target identifier associated with the target system. If the machine information conflicts with the target identifier, the lock module may output a warning message associated with the target system, prevent access to at least a portion of the target system, render at least a portion of the digital content stored on the target system inaccessible or any combination thereof.

The deployment system may still further include processor executable instructions to store an instance of a watermark code with an association to a corresponding target system, and transfer a registration module to the target system for registering the digital content with a registration server. The registration module may include instructions executable by the target system to establish contact with the registration server via a network connection available to the target system, and send an indication of at least one watermark code stored on the target system to the registration server.

In certain embodiments, the deployment system itself may include the registration server. The memory media may further include processor executable instructions to receive the indication of the at least one current watermark code stored on the target system, and determine deployment characteristics of the software image, including identifying an instance of a deployment application that deployed the software image. The deployment system may further include processor executable instructions to determine that at least one current watermark code stored on the target system is an exact copy of a watermark code stored on a different target system. The deployment system may still further include processor executable instructions to determine that at least one current watermark code stored on the target system is different from another watermark code stored on the target system.

In yet another aspect, a disclosed computer-readable memory media may include executable instructions for deploying a watermarked target system. The instructions may be executable to create a unique, encrypted watermark code including machine information indicative of a deployment system and a target system, and to transfer digital content, including one or more instances of the watermark code, to the target system. The watermark code may further include state information indicative of a date and a time associated with the transfer to the target system. The state information may include a unique identifier associated with the digital content. In one embodiment, the executable instructions to transfer further include executable instructions to transfer at least one watermark code by addressing a location of a storage partition on the target system.

In some embodiments, the memory media may further include instructions executable to transfer a lock module to the target system for locking the digital content. The memory media may still further include instructions executable to transfer a registration module to the target system for registering the digital content with a registration server. The registration module may include instructions executable by the target system to establish contact with the registration server via a network connection available to the target system, and register the watermark code with the registration server with an association to the target system. The registration module may further include instructions executable by the target system to register the digital content with the registration server under the association to the target system.

In yet another aspect, a disclosed method of accessing watermark codes stored on a target system includes installing a detection application on the target system. The detection application may be configured to locate at least one watermark code stored on the target system and further configured to perform one or more watermark interaction steps including, as examples, recording located watermark codes, analyzing located water mark codes, displaying located watermark codes, and displaying information derived from located watermark codes.

Installing the detection application may be achieved by connecting a detection device to the target system via a local connection interface, wherein the detection device includes memory media containing the detection application. In one implementation, the detection device is a memory stick, thumb drive, or other form of portable storage device and the local connection interface comprises a universal serial bus.

In the following description, details are set forth by way of example to facilitate discussion of the disclosed subject matter. It should be apparent to a person of ordinary skill in the field, however, that the disclosed embodiments are exemplary and not exhaustive of all possible embodiments.

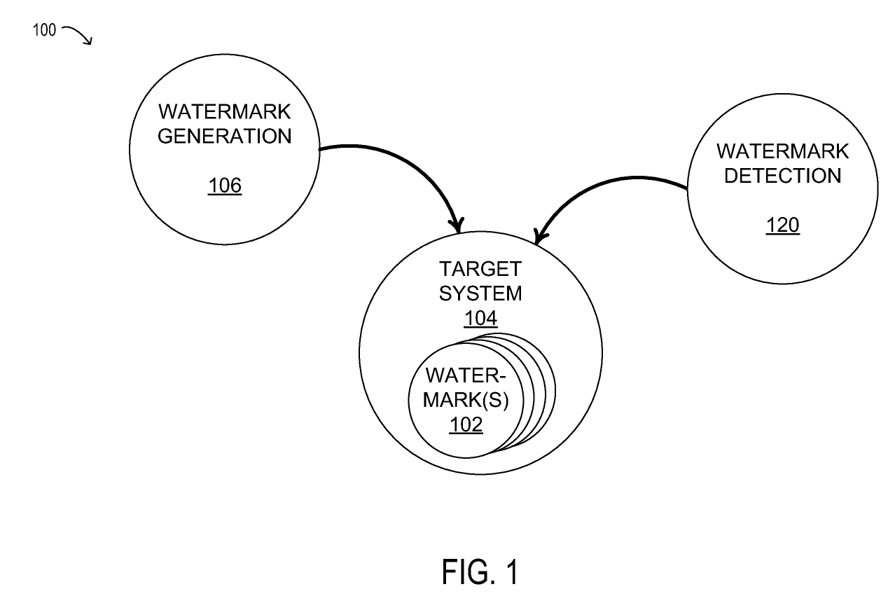

Referring now to FIG. 1, a block diagram of selected elements of an embodiment of a watermarking system 100 are presented. Watermarking system 100 is depicted in generalized form for clarity. Watermarking system 100 as depicted in FIG. 1 includes watermark generation 106 representing various systems and components that perform corresponding actions for generating watermark codes 102. Watermark generation 106 may include one or more deployment systems, network systems, database systems, as well as other industrial systems. Watermark generation 106 may further interact with other external systems (not shown in FIG. 1), such as manufacturing systems, supply chain systems, order systems, inventory systems, etc. Watermark generation 106 may thus represent one or more business entities involved with generating watermark codes 102.

In particular embodiments, watermark generation 106 may encompass systems and components configured to generate and deploy watermark codes 102 to a number of distributed target systems 104. Target systems 104 may thus represent individual systems in possession of a plurality of users at a corresponding plurality of locations. Watermark generation 106 may further be configured to ‘push’ digital content and watermark codes 102 by automatic transfer to target systems 104. Target systems 104 may also ‘pull’ digital content and watermark codes 102 by issuing requests to watermark generation 106 and receiving requested items in response thereto.

In FIG. 1, watermarking system 100 also includes target system 104, on which a plurality of watermark codes 102 may be stored. Target system 104 is a generalized representation that may refer to any of a large number of individual target systems. Target system 104 may be manufactured at a facility where actions by watermark generation 106 are performed. Target system 104 may subsequently be delivered to a distributor or reseller (not shown in FIG. 1), or ultimately be in possession of an end user (not shown in FIG. 1). The end user may be a private individual, or a member of an organization providing the end user with target system 104 for personal use. Thus, the connectivity between watermark generation 106 and target system 104 may be limited to a period of deployment of target system 104.

Watermarking system 100 is also shown in FIG. 1 with watermark detection 120, representing various systems and components, which may perform detection actions on watermark codes 102 subsequent to watermark generation 106. Accordingly, the connectivity between watermark detection 120 and target system 104 may be over a period of life-time usage of target system 104. Watermark detection 120 may be interact continuously, intermittently, or sporadically (e.g., on demand) with target system 104. The detection actions performed by watermark detection 120 may serve to secure digital content (not shown in FIG. 1) deployed on target system 104 by validating watermark codes 102 and performing additional actions in response to the results of the validating.

It is noted that watermark detection 120 may be configured to operate either with or without prior knowledge of a particular watermark code 102 on a particular target system 104. That is, in one embodiment, watermark detection 120 may be configured to read watermark codes 102 on target system 104, and perform various detection functions based on the content of watermark codes 102. In different embodiments, watermark detection 120 may include, or may have access to, additional repositories of information about target system 104, and may be configured to look up or index target system 104 based on information stored in watermark codes 102. In certain embodiments, watermark detection 120 may be configured to perform enforcement actions, such as a notification action or a locking action, upon detecting a license violation on target system 104.

It is further noted that watermark detection 120 may be embodied in various implementations. In certain embodiments, watermark detection 120 may operate in a mass production facility configured to handle a large number of target systems, such as target system 104. In one embodiment, watermark detection 120 may be configured to operate via a public or private network connection, such as the Internet or a corporate network system. In various embodiments, watermark detection 120 may be performed by direct interaction with target system 104, such as by executing watermark interaction code on target system 104 or on a device that can be connected to target system 104. As will be described in further detail herein, the executable code may be configured to read and interpret watermark codes 102, identify target system 104, and may further include instructions executable to communicate with external entities via a network connection.

In FIG. 1, watermark codes 102 may include machine information and state information (not shown in FIG. 1). The machine information may be associated with an identity of a particular system, such as a deployment system included in watermark generation 106 or target system 104. The state information may include global environmental information, such as a date and time associated with the deployment, or information associated with the digital content. Watermark codes 102 may also include additional information, as desired. In a particular embodiment, watermark codes 102 are 128-bit encrypted codes.

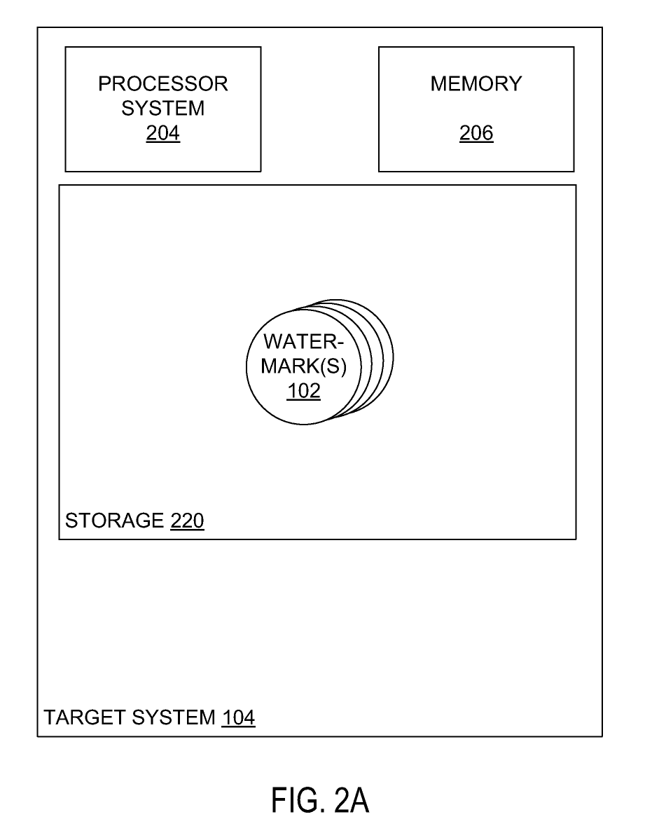

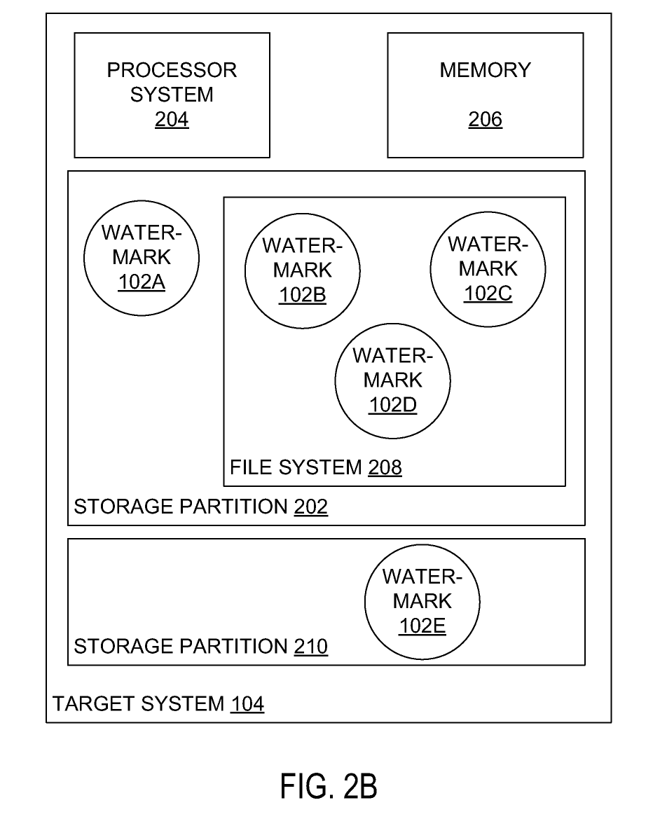

Turning now to FIG. 2A, a block diagram of selected elements of a generalized embodiment of target system 104 is illustrated. In the embodiment depicted in FIG. 2A, target system 104 includes processor system 204 which may access memory 206 for storing and retrieving processor executable instructions. Memory 206 may be volatile or non-volatile memory, and may represent memory elements physically integrated in processor system 204, such as cache memory. Memory 206 may further be coupled to storage 220, representing non-volatile storage resources configured for use with target system 104. Processor system 204, memory 206 and storage 220 may be interconnected using at least one bus system, as desired (not shown in FIG. 2A). As shown in FIG. 2A, storage 220 may store a plurality of watermark codes 102.

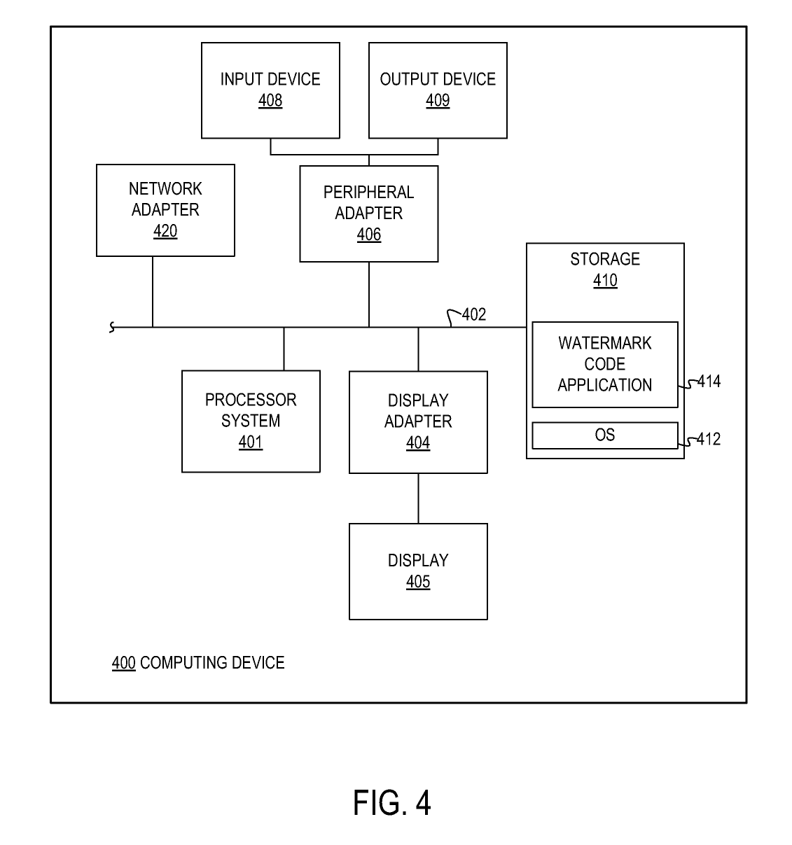

Turning now to FIG. 2B, a block diagram of selected elements of an alternative embodiment of target system 104 is illustrated. Target system 104 is shown in additional detail in FIG. 2B as an exemplary embodiment of a deployed target system, as described above with respect to FIGS. 1 and 2A. In various embodiments, target system 104 may be configured as a generalized computing device (see FIG. 4), of which selected elements have been omitted for clarity in FIG. 2B.

In the embodiment depicted in FIG. 2B, target system 104 includes processor system 204 which may access memory 206 for storing and retrieving processor executable instructions. Memory 206 may be volatile or non-volatile memory, and may represent memory elements physically integrated in processor system 204, such as cache memory. Memory 206 may further be coupled to storage partition 202 and storage partition 210, representing non-volatile storage resources configured for use with target system 104. Processor system 204, memory 206 and storage partitions 202, 210 may be interconnected using at least one bus system, as desired (not shown in FIG. 2B).

As shown in FIG. 2B, storage partitions 202 and 210 represent two logical partitions accessible by target system 104 using logical addressing to provide a fixed or variable storage capacity. In one embodiment, storage partition 202 may be a boot partition, while storage partition 210 may be a data partition. Storage partitions 202, 210 may store digital content, such as a software image, created during deployment of target system 104. Storage partitions 202, 210 may thus store applications or executable programs comprising processor executable code, which may be loaded into memory 206 for execution by processor 204.

Storage partitions 202, 210 may be physically implemented using local storage devices, a storage subsystem, or a distributed storage system, such as a storage-area-network (SAN) or a network-area-storage (NAS). Storage partition 202 is shown in FIG. 2B including file system 208, which may occupy at least a portion of a storage volume created on storage partition 202. Storage partition 210 is shown without a file system and may be accessed using direct addressing of physical storage locations (e.g., addressable sectors in the partition). In one embodiment, an address for storing at least one of the watermark codes, such as watermark code 102A and/or 102E, may be based at least in part on the watermark code itself. That is, watermark code 102 may include a storage address, or may be used to calculate the storage address.

As used herein, a “file system” refers to executable code for organizing a storage partition, such that access to the storage partition is provided using hierarchical information specifying files and directories. The hierarchical information may not specify a physical location on the storage partition on which the file system is created. The file system provides the hierarchical interpretation externally, while managing the physical location addressing of the storage partition internally. In this manner, the data in a given data file may physically occupy various locations, either segmented or contiguous, while appearing outwardly as a single contiguous entity.

In FIG. 2B, target system 104 is shown with five watermark codes 102A-E, which may have been created and transferred to target system 104 during deployment. Watermark codes 102A and 102E represent watermark codes that are stored at addressed locations in storage partitions 202 and 210, respectively. In other words, watermark codes 102A and 102E may not be accessible via file system 208. In contrast, watermark codes 102B, 102C, and 102D represent watermark codes that are stored in different data files (not shown in FIG. 2B) under file system 208. Watermark codes 102B-D may be stored in data files in directories associated with different applications in a software image (not shown in FIG. 2B) of target system 104. In certain embodiments, watermark codes 102B-D are stored in data files with particular attributes, such as hidden, system, etc., to avoid general detection and corruption. In various embodiments, watermark codes 102B-D are embedded in data files along with additional file content.

To avoid confusion or misinterpretation of watermark codes 102A-E as malicious content, watermark codes 102A-E may be registered with an entity providing malicious code detection, such that the entity or services provided by the entity do not identify watermark codes 102A-E as malicious code. The malicious code detection entity may be local to target system 104 or may be an external entity.

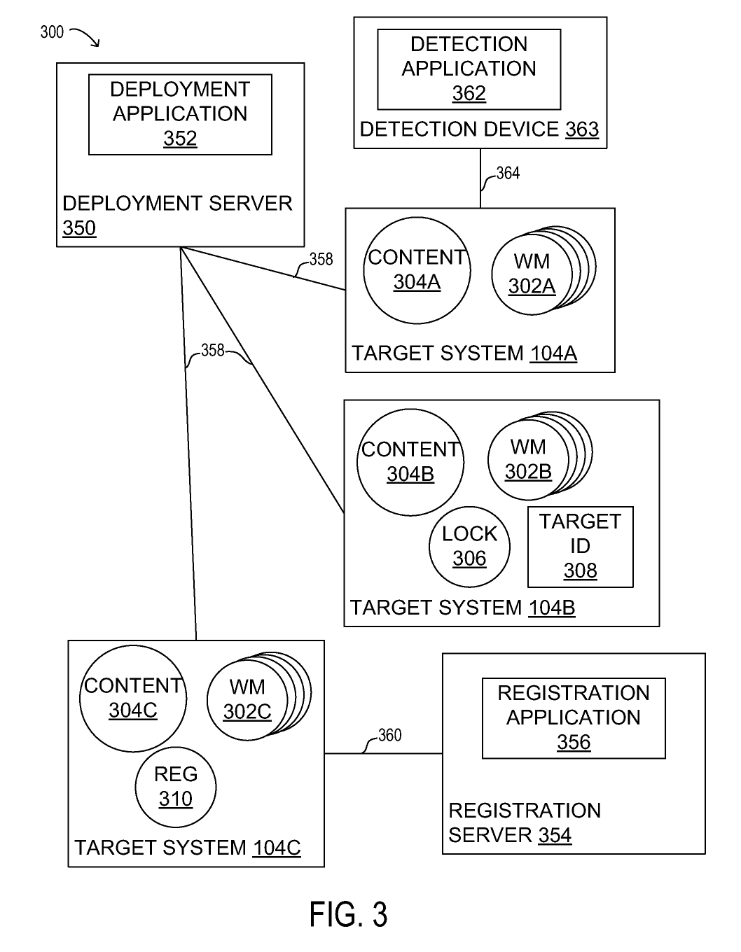

Referring now to FIG. 3, a block diagram of selected elements of an embodiment of a deployment system 300 for deploying watermarked target systems 104 is depicted. In various embodiments, deployment system 300 represents at least some common functionality as described above with respect to watermark generation 106 (see FIG. 1). Deployment system 300 may be implemented as an industrial process for deploying a plurality of target systems 104. Deployment system 300 may be configured to process simultaneously a given number of target systems 104. The total number of target systems 104 processed using deployment system 300 may thus grow to be very large over time.

In FIG. 3, deployment system 300 is shown including deployment server 350 and exemplary target systems 104A-C. While specific embodiments of target systems 104A-C are depicted in FIG. 3 for illustrative purposes, various configurations and combinations of target systems 104 may be processed by deployment system 300, as desired. Also depicted in FIG. 3 is registration server 354, which, in some embodiments, may represent an external component that is not physically included with other elements of deployment system 300. In other embodiments (not depicted in FIG. 3), registration server 354 and deployment server 350 may be implemented as a single system.

As shown in FIG. 3, deployment system 300 includes deployment application 352, which may execute functionality for deploying target systems 104 including, for example, storing software images as well as one or more watermarks on target systems 104. Deployment system 300 may connect to target systems 104 using network connection 358, which may be provided at an industrial facility. Network connection 358 may be a wired, optical, or wireless network connection, and may facilitate simultaneous communication with a plurality of target systems 104. Deployment system 300 may also be in communication with additional business systems (not shown in FIG. 3), such as an order processing system providing access to individual order details. The order details may include a bill of materials associated with a particular target system 104, from which deployment application 352 may obtain the components for a specified software image to be transferred to the target system 104.

In FIG. 3, target systems 104 are shown including content 304 and watermark codes 302—that is, target systems 104 are shown in an exemplary deployed condition. Deployment application 352 may transfer depicted elements to target systems 104 during a deployment process via network connection 358. In one exemplary operation, target system 104 may be connected to deployment system 300 via network 358. Deployment application 352 may recognize target system 104 and may transfer content 304, watermark codes 302, lock module 306, registration module 310, target ID 308, or any combination thereof to target system 104, as desired, during deployment. The deployment process may further include additional installations of content, applications, and or system configuration tasks.

Content 304 may include digital content, such as a software image or other libraries. Watermark codes 302 may include machine information and state information. The machine information may be an indication or an identifier of deployment system 300, target system 104, or both. The state indication may include a date and time associated with the transfer of content 304 to target system 104, and/or information describing content 304, such as license information, serial numbers, etc. Watermark codes 302 may include additional information, as desired. It is noted that watermark codes 302 may be encrypted using a key accessible to deployment application 352 (not shown in FIG. 3) and may be stored on target system 104 in encrypted form.

As shown in FIG. 3, target system 104A depicts one embodiment of watermarking with content 304A and watermark codes 302A. The watermark codes 302A may represent a plurality of watermark codes, such as watermark codes 102A-E described above with respect to FIG. 2B. Target system 104A is shown in a deployed condition without additional executable code. Watermark codes 302A may represent a unique identifier for target system 104A, in that they include traceable information describing deployment system 300, such as, but not limited to, a deployment process performed by deployment application 352, the target system 104A, content 304A, or a combination thereof. In various embodiments, a detection method, for example as represented by watermark detection 120 (see FIG. 1), may be used to detect, read, and interpret watermark codes 302A.

Also depicted in FIG. 3 is a detection device 363 including a detection application 362. Detection device 363 may be connected to target system 104A for the purpose of accessing watermark codes 302A. In one embodiment, detection device 363 may install or otherwise introduce executable code such as detection application 362 on target system 104A via a connection 364. Connection 364 may represent a local or remote network connection. In other embodiment, connection 364 may represent a local interface connection including, as an example, a universal serial bus (USB) connection with target system 104A. In some embodiments, detection device 363 is a portable storage device such as a memory stick, thumb drive, or other similar device configured to install or otherwise transfer detection application 362 to target system 104A when connection 364 is established. Detection application 362 may thus be configured to access target system 104A after deployment of content 304A and watermark codes 302A. Accordingly, detection application 362 may be aware of a stored location and a particular format of watermark codes 302A.

Detection application 362 may further be configured for various types of access on target system 104A. In one embodiment, detection application 362 may copy instances of watermark codes 302A to an external storage medium (not shown in FIG. 3). Detection application 362 may include watermark interaction code for reading and interpreting watermark codes 302A. For example, detection application 362 may be configured to display the contents of watermark codes 302A, such as in a raw and/or interpreted format. Detection application 362 may further be configured to display an indication associated with watermark codes 302A, without explicitly displaying the contents of watermark codes 302A. In one example, detection application 362 may display an indication of the consistency of several instances of watermark codes 302A stored on target system 104A. As discussed above, detection application 362 may be stored on a portable storage device that may be plugged into or otherwise connected to target system 104A. For example, detection application 362 may be stored on a memory stick, thumb drive, or similar device and connected to target system 104A via a USB port.

In FIG. 3, target system 104B is shown including content 304B and watermark codes 302B. Target system 104B is further depicted including lock module 306 and target ID 308. Lock module 306 may represent executable code transferred to target system 104B by deployment application 352. Target ID 308 may represent a unique identifier for target system 104B. In certain instances, target ID 308 may include information transferred by deployment application 352. Target ID 308 may also include information native to target system 104B, including a hardware-specific identifier, such as a processor identifier. Lock module 306 may be executable by target system 104B subsequent to the deployment process performed by deployment application 352. Lock module 306 may be configured to read and interpret at least one of watermark codes 302B and may also access and interpret target ID 308. Lock module 306 may also compare information in watermark codes 302B, such as machine information (not shown in FIG. 3), with target ID 308. In one embodiment, machine information in watermark codes 302B may include a representation of target ID 308. A determination by lock module 306 that the machine information in watermark codes 302B corresponds to target ID 308 may serve as a validation of target system 104B and/or content 304B.

However, a determination by lock module 306 that the machine information in watermark codes 302B conflicts with target ID 308 may be construed by lock module 306 as a sign of invalidity associated with target system 104B and/or content 304B. In certain embodiments, lock module 306 may also interpret inconsistency among separate instances of watermark codes 302B as the sign of invalidity. For example, the sign of invalidity may indicate a violation of a license agreement associated with target system 104B. In response to detecting the sign of invalidity, lock module 306 may execute a watermark violation action. The watermark violation action may include outputting a warning message associated with target system 104B, preventing access to at least a portion of target system 104B or content 304B, rendering at least a portion of content 304B inaccessible, or a combination thereof.

Continuing with FIG. 3, target system 104C is shown including content 304C and watermark codes 302C. Target system 104C is further depicted including registration module 310. Registration module 310 may represent executable code transferred to target system 104C by deployment application 352. Registration module 310 may be executable by target system 104C subsequent to the deployment process performed by deployment application 352. Registration module 310 may be configured to read and interpret at least one of watermark codes 302C. Registration module 310 may also be configured to communicate with registration server 354 via network connection 360. Registration module 310 may notify registration application 356 executing on registration server 354 of the identity of target system 104C, including sending an indication of watermark codes 302C.

As depicted in FIG. 3, registration server 354 and registration application 356 may be implemented separate from deployment system 300, and may be external to deployment system 300 in certain embodiments. In other embodiments, registration server 354 and deployment server 350 may be implemented on the same platform, along with their respective applications, registration application 356 and deployment application 352. In still further embodiments, registration application 356 and deployment application 352 may communicate with each other, or rely upon shared resources, such as a common database or archive system (not shown in FIG. 3).

In FIG. 3, registration application 356 may record information about target system 104C under a unique index associated with watermark codes 302C. Registration application 356 may also record information associated with content 304C, such as usage information or details about a software image included in content 304C (not shown in FIG. 3). For example, registration application 356 may determine certain deployment characteristics of a software image, such as identifying an instance of deployment application 352 that deployed content 304C, including the software image. Registration application 356 may further be configured to track information about target system 104C, along with a plurality of other target systems (not shown in FIG. 3), during a period of usage after deployment. In this manner, registration application 356 may determine watermark violations, which may be indicative of licensing violations or other improper usage of the plurality of target systems. For example, registration application 356 may determine that at least one of watermark codes 302C on target system 104C is an exact copy of a watermark code on a different target system, indicating that watermark code 302C, along with at least some portion of content 304C, may have been improperly copied. In a further example, registration application 356 or registration module 310 may determine that at least one of watermark codes 302C is different from another of watermark codes 302C on target system 104C—that is, watermark codes 302C are not all internally consistent. In this manner, a licensing violation or indication of installation activity on target system 104C may be detected. Registration module 310 may further be configured to perform enforcement actions in response to a notification or command received from registration application 356. Registration application 356 may further be used in the event that a restoration of the deployed state of target system 104C is desired.

Referring now to FIG. 4, a block diagram illustrating selected elements of an embodiment of a computing device 400 is presented. In various embodiments, computing device 400 may represent an instance of deployment server 350, target system 104, and registration server 354, or other components in deployment systems 100 and 300 (see FIGS. 1-3).

In the embodiment depicted in FIG. 4, device 400 includes processor 401 coupled via shared bus 402 to storage media collectively identified as storage 410. Device 400, as depicted in FIG. 4, further includes network adapter 420 that interfaces device 400 to a network (not shown in FIG. 4). In embodiments suitable for use adaptive application interface management, device 400, as depicted in FIG. 4, may include peripheral adapter 406, which provides connectivity for the use of input device 408 and output device 409. Input device 408 may represent a device for user input, such as a keyboard or a mouse, or even a video camera. Output device 409 may represent a device for providing signals or indications to a user, such as loudspeakers for generating audio signals.

Device 400 is shown in FIG. 4 including display adapter 404 and further includes a display device or, more simply, a display 405. Display adapter 404 may interface shared bus 402, or another bus, with an output port for one or more displays, such as display 405. Display 405 may be implemented as a liquid crystal display screen, a computer monitor, a television or the like. Display 405 may comply with a display standard for the corresponding type of display. Standards for computer monitors include analog standards such as VGA, XGA, etc., or digital standards such as DVI, HDMI, among others. A television display may comply with standards such as NTSC (National Television System Committee), PAL (Phase Alternating Line), or another suitable standard.

Display 405 may include an output device 409, such as one or more integrated speakers to play audio content, or may include an input device 408, such as a microphone or video camera. In some embodiments, device 400 may be configured without (i.e., may exclude) at least one of input device 408, output device 409, and display 405.

Storage 410 encompasses persistent and volatile memory media, fixed and removable memory media, and magnetic and semiconductor memory media. Storage 410 is operable to store instructions, data, or both. Storage 410 as shown includes sets or sequences of instructions, namely, an operating system 412, and watermark code application 414. Operating system 412 may be a UNIX or UNIX-like operating system, a Windows® family operating system, or another suitable operating system.

It is noted that in different embodiments watermark code application 414 may represent different functionality, such as processor executable instructions, provided by deployment application 352, lock module 306, registration module 310, registration application 356, or a combination thereof (see FIG. 3).

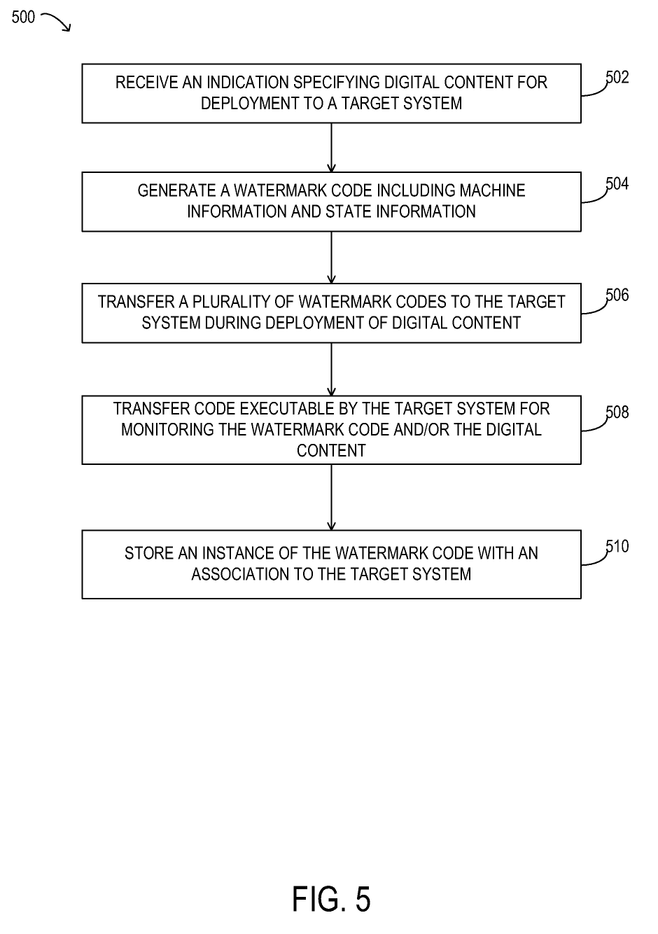

Advancing now to FIG. 5, a diagram of one embodiment of deployment method 500 is illustrated in flow chart form. Method 500 may be executed by deployment application 352 (see FIG. 3). In various embodiments, operations in method 500 may be omitted or rearranged, as desired.

An indication specifying digital content for deployment to a target system may be received (operation 502). In a mass manufacturing environment, the indication may specify individual components of a software image to be installed on the target system, and may be received from an external business system. Access to the digital content may also be provided for the purpose of transferring the digital content to the target system. A connection to the target system may be established, and other operations for preparing the deployment may also be performed in association with operation 502. A watermark code, including machine information and state information, may be generated (operation 504). The watermark code may be unique to the target system and the machine information may further include an indication of a deployment server. In one embodiment, the machine information includes a network device identification, such as a Media Control Access (MAC) address identifier for a particular network adapter. The state information may include an indication of the digital content to be transferred to the target system. The state information may further include a date and time associated with the execution of method 500.

Then, during deployment of the digital content, a plurality of watermark codes may be transferred to the target system (operation 506). The plurality of watermark codes may be different instances of an identical watermark code. The watermark codes may be written to at least one storage partition configured for access by the target system. At least one watermark code may be written to a data file on the target system. Data files including the watermark code may be stored at file system locations associated with specific applications in a software image.

Further, code executable by the target system may be transferred to the target system for monitoring the watermark codes and/or the digital content (operation 508). In certain embodiments, operation 508 may be optional or may be omitted. The executable code may be in the form of lock module 306 or registration module 310 (see FIG. 3). The target system may be configured to execute the executable code at a later time or in response to a particular event.

Finally, an instance of the watermark code may be stored with an association to the target system (operation 510). The instance of the watermark code in operation 510 may be stored in a central repository including information for a plurality of target systems. The instance of the watermark code transferred in operation 510 may be stored along with an archive copy of the deployed digital content in association with the target system, such as a mirror image of the storage partition.

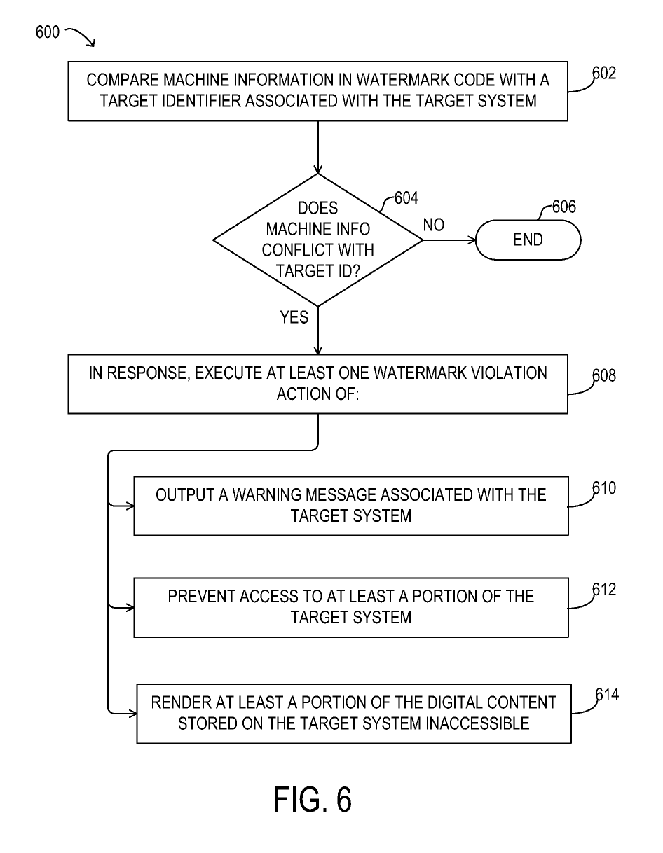

Turning now to FIG. 6, a diagram of one embodiment of lock method 600 is illustrated in flow chart form. Method 600 may be executed by lock module 306 (see FIG. 3) on a target system at some point in time subsequent to the deployment of the target system, as described above. In various embodiments, operations in method 600 may be omitted or rearranged, as desired.

Machine information in a watermark code may be compared with a target identifier associated with the target system (operation 602). The watermark code and the target identifier may be read and parsed locally on the target system. The target identifier may be a unique hardware-specific identifier of at least one hardware component included in the target system. Then, a decision may be made if the machine information conflicts with the target identifier (operation 604). If the result of operation 604 is NO, then method 600 may terminate (operation 606). Termination in operation 606 may indicate that no watermark violations were detected on the target system, including internal inconsistencies among instances of watermark codes stored on the target system.

In FIG. 6, if the result of operation 604 is YES, then in response, at least one watermark violation action may be executed (operation 608). The watermark violation action(s) may be at least one of operations 610, 612, and 614. A warning message associated with the target may be output (operation 610). The warning message may be output to a user of the target system. If a network connection is available, the warning message may be output to an entity associated with the target system or with digital content stored on the target system. Access to at least a portion of the target system may be prevented (operation 612). The portion of the target system may be a hardware and/or software portion. The portion may be associated with the digital content or a particular application in a software image. Prevention of access may be whole or in part, such that a remedial manner of access may continue to be granted. The prevented access may be dependent upon an identity of a user of the target system. At least a portion of the digital content stored on the target system may be rendered inaccessible (operation 614). At least a portion of the digital content may be permanently rendered inaccessible, for example, by destroying the stored representation of the content. In certain embodiments, physical damage to a storage device configured for use with the target system may be performed in operation 614. In various embodiments, at least a portion of the digital content may be recoverably rendered inaccessible, for example, by deleting a pointer or reference to the stored representation of the content. The content may be rendered inaccessible to a particular user of the target system. The portion may be associated with the digital content or a particular application in a software image.

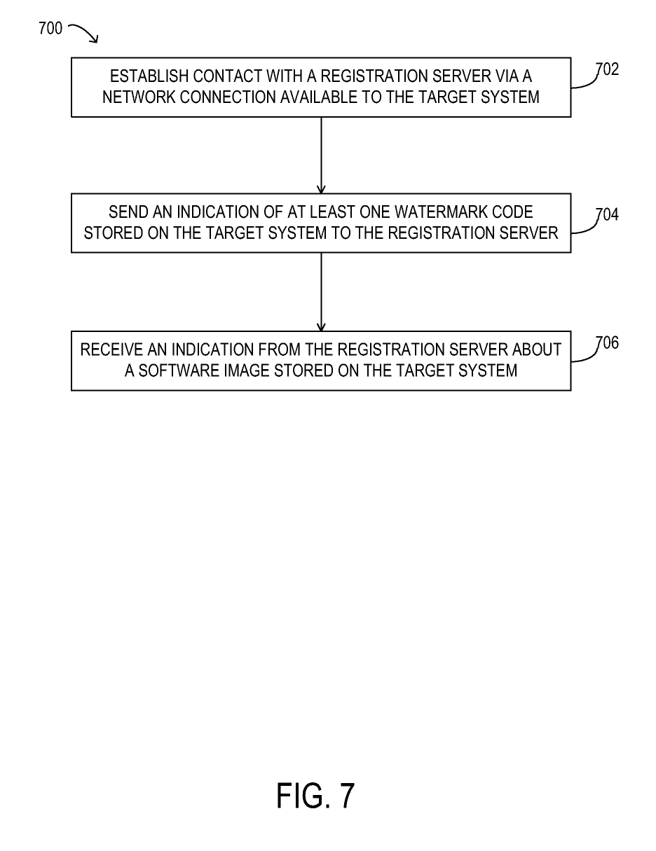

Referring now to FIG. 7, a diagram of selected elements of one embodiment of registration method 700 is illustrated in flow chart form. Method 700 may be executed by registration module 310 (see FIG. 3) on a target system at some point in time subsequent to the deployment of the target system, as described above. In various embodiments, operations in method 700 may be omitted or rearranged, as desired.

Contact may be established with a registration server via a network connection available to the target system (operation 702). The registration server may be configured to execute a registration application and may be configured to operate with a plurality of target systems. An indication of at least one watermark code stored on the target system may be sent to the registration server (operation 704). The registration server may record the indication under an index to the target system. An indication about a software image stored on the target system may be received from the registration server (operation 706). The indication may describe whether or not a watermark violation has occurred in conjunction with the target system.

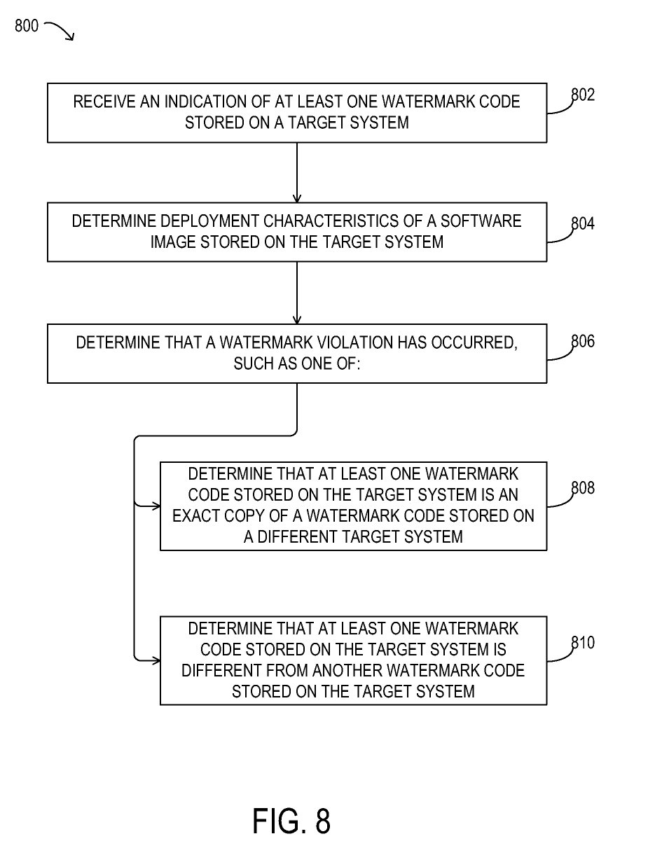

Referring now to FIG. 8, a diagram of selected elements of one embodiment of registration method 800 is illustrated in flow chart form. Method 800 may be executed by registration application 356 (see FIG. 3) on a registration server at some point in time subsequent to the deployment of the target system, as described above. In various embodiments, operations in method 800 may be omitted or rearranged, as desired.

An indication of at least one watermark code stored on a target system may be received (operation 802). The indication of the at least one watermark code may be stored under an index to the target system. Then, deployment characteristics of a software image stored on the software system may be determined (operation 804). The determination in operation 804 may be at least one of operations 806 and 808. At least one watermark code stored on the target system may be determined to be an exact copy of a watermark code stored on a different target system (operation 806). At least one watermark code stored on the target system may be determined to be different from another watermark code stored on the target system (operation 808). A watermark violation action may further be performed in response to such determinations.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for watermarking a target system, comprising:
generating a watermark code including machine information and state information; and
transferring a plurality of instances of the watermark code to the target system.

2. The method of claim 1, wherein the watermark code is an encrypted code.

3. The method of claim 1, wherein at least one instance of the watermark code is transferred to a data file.

4. The method of claim 1, wherein at least one instance of the watermark code is transferred by addressing a location of a storage partition accessible to the target system.

5. The method of claim 1, wherein said transferring is performed during deployment of digital content to the target system.

6. The method of claim 5, wherein the machine information includes server information specific to a server performing said deployment.

7. The method of claim 5, wherein the state information includes date and time information associated with said deployment.

8. The method of claim 5, wherein at least one watermark code is transferred to a network server.

9. The method of claim 5, wherein said deployment includes creating a plurality of storage partitions including a boot partition and a data partition.

10. The method of claim 9, wherein at least one watermark code is transferred to the boot partition.

11. The method of claim 1, wherein the machine information includes target system information specific to the target system.

12. The method of claim 1, wherein the state information includes version information for digital content loaded on the target system.

13. The method of claim 1, wherein said transferring the plurality of watermark codes includes:
determining an address for storing at least one of the watermark codes based at least in part on the watermark code.

14. A deployment system for deploying a software image to a target system, comprising:
a processor;
an I/O port configured for enabling communication between the deployment system and the target system; and
memory media accessible to the processor, including processor executable instructions to:
receive an indication specifying the software image to be deployed to the target system;
create a unique, encrypted watermark code associated with the target system;
deploy the specified image to the target system; and
store at least one instance of the watermark code on the target system.

15. The system of claim 14, wherein at least one instance of the watermark code is transferred to a data file in a file system on the target system, and wherein at least one instance of the watermark code is transferred by addressing a location of a storage partition on the target system.

16. The system of claim 14, wherein the watermark code includes machine information and state information.

17. The system of claim 16, further comprising processor executable instructions to:
transfer a lock module to the target system for locking the software image, wherein the lock module includes instructions executable by the target system to:
compare the machine information with a target identifier associated with the target system; and
if the machine information conflicts with the target identifier, execute at least one of: output a warning message associated with the target system, prevent access to at least a portion of the target system, and render at least a portion of the digital content stored on the target system inaccessible.

18. The system of claim 14, further comprising processor executable instructions to:
store an instance of the watermark code with an association to the target system;
transfer a registration module to the target system for registering the digital content with a registration server, wherein the registration module includes instructions executable by the target system to:
establish contact with the registration server via a network connection available to the target system; and
send an indication of at least one watermark code stored on the target system to the registration server.

19. The system of claim 18, wherein the deployment system includes the registration server, and further comprising processor executable instructions to:
receive the indication of the at least one current watermark code stored on the target system; and
determine deployment characteristics of the software image, including identifying an instance of a deployment application that deployed the software image.

20. The system of claim 18, further comprising processor executable instructions to:
determine that at least one current watermark code stored on the target system is an exact copy of a watermark code stored on a different target system.

21. The system of claim 18, further comprising processor executable instructions to:
determine that at least one current watermark code stored on the target system is different from another watermark code stored on the target system.

22. Computer-readable memory media, including executable instructions for deploying a watermarked target system, said instructions executable to:
create a unique, encrypted watermark code including machine information indicative of at least one of: a deployment server and a target system; and
transfer digital content, including a plurality of instances of the watermark code, to the target system.

23. The memory media of claim 22, wherein at least one instance of the watermark code is transferred to a data file.

24. The memory media of claim 22, wherein the watermark code further includes state information indicative of a date and a time associated with said transfer to the target system.

25. The memory media of claim 24, wherein the state information includes a unique identifier associated with the digital content.

26. The memory media of claim 22, wherein said executable instructions to transfer further include executable instructions to:
transfer at least one watermark code by addressing a location of a storage partition on the target system.

27. The memory media of claim 22, further comprising executable instructions to:
transfer a lock module to the target system for locking the digital content, wherein the lock module includes instructions executable by the target system to:
compare the machine information with a target identifier associated with the target system; and
if the machine information conflicts with the target identifier, execute at least one of: output a warning message associated with the target system, prevent access to at least a portion of the target system, and render at least a portion of the digital content stored on the target system inaccessible.

28. The memory media of claim 22, further comprising executable instructions to:
transfer a registration module to the target system for registering the digital content with a registration server, wherein the registration module includes instructions executable by the target system to:
establish contact with the registration server via a network connection available to the target system; and
register the watermark code with the registration server with an association to the target system.

29. The memory media of claim 28, wherein the registration module further includes instructions executable by the target system to:
register the digital content with the registration server under the association to the target system.

30. A method for accessing a watermarked system, comprising:
executing watermark interaction code configured for accessing at least one watermark code stored on the watermarked system, wherein the watermark code includes machine information and state information.

31. The method of claim 30, wherein the executable code is configured to copy the at least one watermark code to an external storage device.

32. The method of claim 30, wherein the executable code is configured to read or to interpret the at least one watermark code.

33. The method of claim 32, wherein the executable code is configured to output an indication associated with the at least one watermark code.

34. A method of accessing watermark codes stored on a target system, comprising installing a detection application on the target system, wherein the detection application is configured to locate at least one watermark code stored on the target system and further configured to perform at least one of: recording located watermark codes, analyzing located water mark codes, displaying located watermark codes, and displaying information derived from located watermark codes.

35. The method of claim 34, wherein said installing comprises connecting a detection device to the target system via a local connection interface, wherein the detecting device includes memory media containing the detection application.

36. The method of claim 35, wherein the detection device comprises a portable storage device and wherein the local connection interface comprises a universal serial bus.
